(19) United States
(12) Patent Application Publication
(10) Pub. No.: US 2023/0106193 A1
(43) Pub. Date: Apr. 6, 2023

(54) CATHODE MATERIAL AND PROCESS

(71) Applicant: EV METALS UK LIMITED, London (GB)

(72) Inventors: Joanna Helen CLARK, Reading (GB); Andrew DIAMOND, Billingham (GB); Eva-Maria HAMMER, Reading (GB); Olivia Rose WALE, Reading (GB)

(21) Appl. No.: 17/907,197

(22) PCT Filed: Mar. 25, 2021
(86) PCT No.: PCT/GB2021/050728

§ 371 Date: Sep. 23, 2022

(30) Foreign Application Priority Data
Mar. 27, 2020 (GB) 2004475.6

(51) Int. Cl. H01M 4/525; H01M 10/0525; H01M 4/505; H01M 4/485; H01M 4/04

(52) U.S. Cl. CPC H01M 4/525; H01M 10/0525; H01M 4/505; H01M 4/485; H01M 4/0471; H01M 2004/028

(57) ABSTRACT

The invention relates to improved particulate lithium nickel oxide materials which are useful as cathode materials in lithium secondary batteries. The invention also provides processes for preparing such lithium nickel oxide materials, and electrodes and cells comprising the materials.

### FIELD OF THE INVENTION

The present invention relates to improved particulate lithium nickel oxide materials which are useful as cathode materials in lithium secondary batteries. The present invention also provides processes for preparing such lithium nickel oxide materials, and electrodes and cells comprising the materials.

### BACKGROUND OF THE INVENTION

Lithium transition metal oxide materials having the formula LiMO₂, where M typically includes one or more transition metals, find utility as cathode materials in lithium ion batteries. Examples include LiNiO₂ and LiCoO₂.

U.S. Pat. No. 6,921,609 B2 describes a composition suitable for use as a cathode material of a lithium battery which includes a core composition having an empirical formula LiₓM′_{z}Ni_{1-y}M″_{y}O₂ and a coating on the core which has a greater ratio of Co to Ni than the core.

WO 2013/025328 A1 describes a particle including a plurality of crystallites including a first composition having a layered α-NaFeO₂-type structure. The particles include a grain boundary between adjacent crystallites, and the concentration of cobalt in the grain boundaries is greater than the concentration of cobalt in the crystallites. Cobalt enrichment is achieved by treatment of the particles with a solution of LiNO₃ and Co(NO₃)₂, followed by spray drying and calcining.

With demand increasing for lithium-ion batteries in high-end applications such as electric vehicles (EVs), it is imperative to use cathode materials which provide not only acceptable specific capacity but also excellent retention of that capacity over a large number of charging cycles, so that the range of the vehicle after each charge over its lifetime is as consistent as possible. Capacity retention is also commonly referred to simply as the “cyclability” of the battery.

There therefore remains a need for improved lithium transition metal oxide materials and processes for their manufacture. In particular, there remains a need for improvements in the capacity retention of lithium transition metal oxide materials when used as cathode materials in lithium secondary batteries.

### SUMMARY OF THE INVENTION

The present inventors have found that the presence of both magnesium and cobalt in particulate lithium nickel oxide cathode materials can enhance their capacity retention. As demonstrated in the Examples below, capacity retention has a strong dependence on magnesium content, but increasing magnesium content to too high levels has a detrimental impact on specific capacity. Similarly, the Examples demonstrate that increasing cobalt content also enhances capacity retention, but that capacity retention depends more strongly on the content of cobalt in an enriched layer at the surface of the particles than it does on cobalt content in the core. In addition, there is no correlation between increasing the cobalt content in the surface layer of the material and a reduction in capacity. Therefore, providing materials with increased cobalt content in a surface enriched layer (and optionally reducing magnesium and/or core cobalt content as a consequence) is highly advantageous.

Accordingly, a first aspect of the invention is a surface-modified particulate lithium nickel oxide material comprising particles having Formula I

LiₐNiₓCo_{y}Mg_{z}AlₚM_{q}O_{2+b} Formula I

in which:
0.8≤a≤1.2
0.8≤x<1
0.010≤y≤0.12
0.007≤z≤0.030
0≤p≤0.01
0≤q≤0.2; and
−0.2≤b≤0.2;
wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof; and

wherein the particles comprise a core and an enriched surface layer at the surface of the core, and wherein the enriched surface layer includes 0.8 wt % or more cobalt based on the total weight of the particle.

A second aspect of the invention is a process for preparing particulate lithium nickel oxide material having Formula I

LiₐNiₓCo_{y}Mg_{z}AlₚM_{q}O_{2+b} Formula I

in which:
0.8≤a≤1.2
0.8≤x<1
0.010≤y≤0.12
0.010≤z≤0.030
0≤p≤0.01
0≤q≤0.2; and
−0.2≤b≤0.2;
wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof; and

the process comprising the steps of:
mixing lithium-containing compound with a nickel-containing compound, a cobalt-containing compound, a magnesium-containing compound and optionally an M-containing compound and/or an aluminium-containing compound, wherein a single compound may optionally contain two or more of Ni, Co, Mg, Al and M, to obtain a mixture;
calcining the mixture to obtain a calcined material; and
contacting the first calcined material with a cobalt containing compound and optionally one or more of an aluminium-containing compound, a lithium-containing compound and an M-containing compound in a surface-modification step to form an enriched surface layer on the first calcined material, such that the enriched surface layer includes 0.8 wt % or more cobalt based on the total weight of the particle.

A third aspect of the invention provides particulate lithium nickel oxide obtained or obtainable by a process described herein.

A fourth aspect of the invention provides a cathode material for a lithium secondary battery comprising the particulate lithium nickel oxide material according to the first aspect.

A fifth aspect of the invention provides a cathode comprising the particulate lithium nickel oxide material according to the first aspect.

A sixth aspect of the invention provides a lithium secondary cell or battery (e.g. a secondary lithium ion battery) comprising the cathode according to the fifth aspect. The battery typically further comprises an anode and an electrolyte.

A seventh aspect of the invention provides use of the particulate lithium nickel oxide according to the first aspect for the preparation of a cathode of a secondary lithium battery (e.g. a secondary lithium ion battery).

An eighth aspect of the invention provides the use of the particulate lithium nickel oxide according to the first aspect as a cathode material to improve the capacity retention or cyclability of a lithium secondary cell or battery.

A ninth aspect is a method of improving the capacity retention or cyclability of a lithium secondary cell or battery, comprising the use of a cathode material in the cell or battery, wherein the cathode material comprises the particulate lithium nickel oxide material according to the first aspect.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise. It is intended that upper and lower limits of ranges are independently combinable, and that the various ranges and values given for a, b, x, y, z, p and q are combinable with each other and with the other features recited herein.

The particulate lithium nickel oxide material has a composition according to Formula I defined above. The compositions recited herein may be determined by Inductively Coupled Plasma (ICP) analysis as described in the Examples section below. It may be preferred that the compositions recited herein are ICP compositions. Similarly, the wt % content of elements in the particulate lithium nickel oxide materials may be determined using ICP analysis. The wt % values recited herein are determined by ICP and are with respect to the total weight of the particle analysed (except wt % lithium carbonate which is defined separately below).

In Formula I, 0.8≤a≤1.2. In some embodiments a is greater than or equal to 0.9, 0.95, 0.99 or 1.0. In some embodiments, a is less than or equal to 1.1, or less than or equal to 1.05. In some embodiments, 0.90≤a≤1.10, for example 0.95≤a≤1.05. In some embodiments, 0.99≤a≤1.05 or 1.0≤a≤1.05. It may be particularly preferred that 0.95≤a≤1.05.

In Formula I, 0.8≤x<1. In some embodiments, 0.85≤x<1 or 0.9≤x<1. In some embodiments, x is less than or equal to 0.99, 0.98, 0.97, 0.96 or 0.95. In some embodiments, x is great than or equal to 0.85, 0.9 or 0.95. In some embodiments, 0.8≤x≤0.99, for example 0.85≤x≤0.98, 0.85≤x≤0.98, 0.85≤x≤0.97, 0.85≤x≤0.96 or 0.90≤x≤0.95. It may be particularly preferred that 0.85≤x≤0.98.

In Formula I, 0.010≤y≤0.12. In some embodiments y is greater than or equal to 0.03, 0.05, 0.055 or 0.06. Including at least this much cobalt in the overall composition provides excellent capacity retention. In some embodiments y is less than or equal to 0.10, 0.095, 0.093, 0.090 or 0.085. In some embodiments, 0.03≤y≤0.095. By shifting the cobalt content to the enriched surface layer in accordance with the present invention it is possible to obtain excellent capacity retention while minimising overall cobalt content. In some embodiments, 0.05≤y≤0.0.09. In some embodiments, 0.055≤y≤0.085.

In Formula I, 0.007≤z≤0.030. In some embodiments z is greater than or equal to 0.008, 0.009, 0.010, 0.012, 0.015, 0.018, 0.020 or 0.022. Mg content of at least this level can provide improved capacity retention. In some embodiments, z is less than or equal to 0.029, 0.028, 0.027, 0.025, 0.022 or 0.020. Avoiding too high a magnesium content can be advantageous as it can lead to higher specific capacity. Where the cobalt content in the surface enriched layer is as provided in the present invention, excellent capacity retention can be obtained even with relatively low magnesium contents.

In Formula I, 0.004≤p≤0.01. In some embodiments, p is less than or equal to 0.0090, 0.0080, 0.0075 or 0.0070. In some embodiments p is greater than or equal to 0.005, 0.0055 or 0.0060. In some embodiments, 0.004≤p≤0.0090, 0.005≤p≤0.008, 0.0055≤p 0.0075 or 0.006≤p≤0.007. It may be particularly preferred that 0.0055≤p≤0.0075 or 0.0055≤p≤0.0080.

In Formula I, −0.2≤b≤0.2. In some embodiments b is greater than or equal to −0.1. In some embodiments b is less than or equal to 0.1. In some embodiments, −0.1≤b≤0.1. In some embodiments, b is 0 or about 0. In some embodiments, b is 0.

In Formula I, M is one or more selected from Mn, V, Ti, B, Zr, Sr, Ca, Cu, Sn, Cr, Fe, Ga, Si, W, Mo, Ta, Y, Sc, Nb, Pb, Ru, Rh and Zn. In some embodiments, M is one or more selected from Mn, V, Ti, B, Zr, Sr, Ca, Cu, Sn, Cr, Fe, Ga, Si and Zn. In some embodiments, M is Mn. In some embodiments, M represents a dopant which is present within the core of the particle but not within the enriched surface layer.

In Formula I, 0≤q≤0.2. In some embodiments, 0≤q≤0.15. In some embodiments, 0≤q≤0.10. In some embodiments, 0≤q≤0.05. In some embodiments, 0≤q≤0.04. In some embodiments, 0≤q≤0.03. In some embodiments, 0≤q≤0.02. In some embodiments, 0 q≤0.01. In some embodiments, q is 0.

In some embodiments:
0.95≤a≤1.05
0.85≤x<1
0.010≤y≤0.10
0.012≤z≤0.030
0.0055≤p≤0.0080
0≤q≤0.2, and
−0.2≤b≤0.2;

wherein M is selected from Al, Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof.

In some embodiments:
0.95≤a≤1.05
0.85≤x<1
0.010≤y≤0.10
0.012≤z≤0.030
0.0055≤p≤0.0080
q=0; and
b=0.

In some embodiments:
0.95≤a≤1.05
0.85≤x<1
0.010≤y≤0.093
0.012≤z≤0.030
0.0055≤p≤0.0080
q=0; and
b=0.

In some embodiments:
0.95≤a≤1.05
0.85≤x<1
0.010≤y≤0.085
0.012≤z≤0.025
0.0055≤p≤0.0080
q=0; and
b=0.

In some embodiments:
0.95≤a≤1.05
0.85≤x<1
0.055≤y≤0.085
0.012≤z≤0.025
0.0055≤p≤0.0080
q=0; and
b=0.

In some embodiments:
0.95≤a≤1.05
0.85≤x<1
0.010≤y≤0.030
0.012≤z≤0.025
0.0055≤p≤0.0080
q=0; and
b=0.

In some embodiments, the particulate lithium nickel oxide material is a crystalline (or substantially crystalline) material. It may have the α-NaFeO₂-type structure. It may be a polycrystalline material, meaning that each particle of lithium nickel oxide material is made up of multiple crystallites (also known as crystal grains or primary particles) which are agglomerated together. The crystal grains are typically separated by grain boundaries. Where the particulate lithium nickel oxide is polycrystalline, it will be understood that the particles of lithium nickel oxide comprising multiple crystals are secondary particles.

The particulate lithium nickel oxide material of Formula I comprises an enriched surface, i.e. comprises a core material which has been surface modified (subjected to a surface modification process) to form an enriched surface layer. In some embodiments the surface modification results from contacting the core material with a Co-containing compound and one or more further metal-containing compounds, and then optionally carrying out calcination of the material. The compounds may be in solution, and in such context herein the term “compound” refers to the corresponding dissolved species. For clarity, the discussions of the composition according to Formula I herein when in the context of surface-modified particles relate to the overall particle, i.e. the particle including the enriched surface layer.

Herein, the terms “surface modified”, “enriched surface” and “enriched surface layer” refer to a particulate material which comprises a core material which has undergone a surface modification or surface enrichment process to increase the concentration of cobalt at or near to the surface of the particles. The term “enriched surface layer” therefore refers to a layer of material at or near to the surface of the particles which contains a greater concentration of cobalt than the remaining material of the particle, i.e. the core of the particle.

In some embodiments, the particle comprises a greater concentration of Al in the enriched surface layer than in the core. In some embodiments, all or substantially all of the Al in the particle is in the enriched surface layer. In some embodiments, the core does not contain Al or contains substantially no Al, for example less than 0.01 wt % Al based on the total particle weight.

As used herein, the content of a given element in the surface enriched layer is calculated by determining the wt % of that element in the particulate lithium nickel oxide material prior to surface enrichment (sometimes referred to herein as the first calcined material or the core material) by ICP to give value A, determining the wt % of that element in the final particulate lithium nickel oxide material after surface enrichment (and optional further calcination) by ICP to give value B, and subtracting value A from value B. Similarly, the content of a given element in the core may be determined by determining the wt % of that element in the particulate lithium nickel oxide material prior to surface enrichment (sometimes referred to herein as the first calcined material or the core material) by ICP.

As the skilled person will understand, elements may migrate between the core and the surface layer during preparation, storage or use of the material. Herein, where an element is stated to be present in (or absent from, or present in certain quantities in) the core, this is to be understood to refer to that element being intentionally added to, (or excluded from, or added in a particular quantity to) the core, and is not intended to exclude from the scope of protection materials where the distribution of elements is altered by migration during preparation, storage or use. Similarly, where an element is stated to be present in (or absent from, or present in certain quantities in) the surface enriched layer, this is to be understood to refer to that element being intentionally added to, (or excluded from, or added in a particular quantity to) the surface enriched layer, and is not intended to exclude from the scope of protection materials where the distribution of elements is altered by migration during preparation, storage or use. For example, where the surface enriched layer includes 0.8 wt % cobalt, this means that 0.8 wt % of the cobalt is added in the surface enrichment step, but does not preclude materials where some of the Co added in the surface enrichment step has migrated into the core.

In some embodiments, the surface enriched layer comprises Co and optionally comprises one or more of Li and Al. In some embodiments the surface enriched layer comprises Co, Al and optionally Li. In some embodiments, the surface enriched layer comprises Co, Al and Li. In some embodiments, the enriched surface layer does not contain any magnesium or nickel, for example contains less than about 0.01 wt % each of magnesium and nickel. In some embodiments, the enriched surface layer contains cobalt and optionally aluminium and/or lithium, but does not contain any magnesium or nickel, for example contains less than about 0.01 wt % each of magnesium and nickel.

In some embodiments, all or substantially all of the magnesium is in the core of the particle. In some embodiments the enriched surface layer contains no magnesium or substantially no magnesium, for example less than 0.01 wt % Mg based on the total particle weight.

In the materials of the present invention, the enriched surface layer includes 0.8 wt % or more cobalt based on the total weight of the particle. In some embodiments the surface enriched layer includes greater than or equal to 1.0, 1.1, 1.2, 1.3, 1.5, 1.8 or 2.0 wt % cobalt. In some embodiments the surface enriched layer includes less than or equal to 3, 2.8, 2.7, 2.5, 2.3 or 2.0 wt % cobalt. The cobalt content in the surface enriched layer is calculated as set out above.

In the materials of the present invention, the core of the material may for example include 0.5 wt % or more of cobalt. It may include 1 or 1.5 wt % or more. It may include 5 wt % or less, for example 4.5, 4, 3.5 or 3 wt % or less.

In some embodiments, the ratio of the mass of material in the enriched surface layer to the mass of material in the core is from 0.01 to 0.04, for example from 0.01 to 0.03, from 0.01 to 0.025 or from 0.014 to 0.022.

The particulate lithium nickel oxide material typically has a D50 particle size of at least 4 μm, e.g. at least 5 μm, at least 5.5 μm, at least 6.0 μm or at least 6.5 μm. The particles of lithium nickel oxide (e.g. secondary particles) typically have a D50 particle size of 20 μm or less, e.g. 15 μm or less or 12 μm or less. In some embodiments, the D50 particle size is from about 5 μm to about 20 μm, for example about 5 μm to about 19 μm, for example about 5 μm to about 18 μm, for example about 5 μm to about 17 μm, for example about 5 μm to about 16 μm, for example about 5 μm to about 15 μm, for example about 5 μm to about 12 μm, for example about 5.5 μm to about 12 μm, for example about 6 μm to about 12 μm, for example about 6.5 μm to about 12 μm, for example about 7 μm to about 12 μm, for example about 7.5 μm to about 12 μm. Unless otherwise specified herein, the D50 particle size refers to Dv50 (volume median diameter) and may be determined by using the method set out in ASTM B822 of 2017 under the Mie scattering approximation, for example using a Malvern Mastersizer 3000.

In some embodiments, the D10 particle size of the material is from about 0.1 μm to about 10 μm, for example about 1 μm to about 10 μm, about 2 μm to about 8 μm, or from about 5 μm to about 7 μm. Unless otherwise specified herein, the D10 particle size refers to Dv10 (10% intercept in the cumulative volume distribution) and may be determined by using the method set out in ASTM B822 of 2017 under the Mie scattering approximation, for example using a Malvern Mastersizer 3000.

In some embodiments, the D90 particle size of the material is from about 10 μm to about 40 μm, for example from about 12 μm to about 35 μm, about 12 μm to about 30 μm, about 15 μm to about 25 μm or from about 16 μm to about 20 μm. Unless otherwise specified herein, the D90 particle size refers to Dv90 (90% intercept in the cumulative volume distribution) and may be determined by using the method set out in ASTM B822 of 2017 under the Mie scattering approximation, for example using a Malvern Mastersizer 3000.

In some embodiments, the tapped density of the particulate lithium nickel oxide is from about 1.9 g/cm³ to about 2.8 g/cm³, e.g. about 1.9 g/cm³ to about 2.4 g/cm³.

The tapped density of the material can suitably be measured by loading a graduated cylinder with 25 mL of powder. The mass of the powder is recorded. The loaded cylinder is transferred to a Copley Tapped Density Tester JV Series. The material is tapped 2000 times and the volume re-measured. The re-measured volume divided by the mass of material is the recorded tap density.

The particulate lithium nickel oxide typically comprises less than 1.5 wt % of surface Li₂CO₃. It may comprise less than 1.4 wt % of surface Li₂CO₃, e.g. less than 1.3 wt %, less than 1.2 wt %, less than 1.1 wt %, less than 1.0 wt %, less than 0.9 wt %, less than 0.8 wt %, less than 0.7 wt % or less than 0.6 wt %. It may have 0 wt % surface Li₂CO₃, but in some embodiments there may be at least 0.01 wt %, 0.02 wt % or 0.04 wt % of surface Li₂CO₃.

The amount of surface Li₂CO₃ may be determined by titration with HCl using bromophenol blue indicator. Typically, a first titration step with HCl and phenolphthalein indicator is carried out before titration with bromophenol blue indicator to remove any lithium hydroxide. The titration protocol may include the following steps:
Extract surface lithium carbonate from sample of particulate lithium nickel oxide material by agitating in deionised water for 5 minutes to provide an extractate solution, and separate extractate solution from residual solid;
Add phenolphthalein indictor to the extractate solution, and titrate using HCl solution until extractate solution becomes clear (indicating the removal of any LiOH);
Add bromophenol blue indictor to the extractate solution, and titrate using HCl solution until extractate solution turns yellow; (the amount of lithium carbonate in the extractate solution can be calculated from this titration step); and
Calculate wt % of surface lithium carbonate in the sample of particulate lithium nickel oxide material, assuming 100% extraction of surface lithium carbonate into the extractate solution.

The particulate lithium nickel oxide of the invention is characterised by an improved capacity retention for cells which incorporate the material as a cathode, in particular a high retention of capacity after 50 cycles. When determined at a temperature of 23° C. in a half cell coin cell vs lithium, under a charge/discharge rate of 1 C and voltage window of 3.0−4.3V, with an electrode loading of 9.0 mg/cm² and an electrode density of 3.0 g/cm³, it has been found that materials according to the invention may provide a capacity retention of greater than 94% after 50 cycles, and in some cases as high as around 98%. The % capacity retention after 50 cycles is defined as the capacity of the cell after the 50^{th} cycle as a percentage of the initial capacity of the cell after its first charge. For clarity, one cycle includes a complete charge and discharge of the cell. For example, 90% capacity retention means that after the 50^{th} cycle the capacity of the cell is 90% of the initial capacity.

An aspect of the invention is a lithium secondary cell or battery wherein the capacity retention of the cell or battery after 50 cycles at 23° C. and a 10 charge/discharge rate and a voltage window of 3.0−4.3V is at least 93%.

The material may have a capacity retention (after 50 cycles in a half cell coin cell vs Li, at an electrode loading of 9.0 mg/cm² and an electrode density of 3.0 g/cm³, tested at 23° C. and a 1 C charge/discharge rate and voltage window of 3.0−4.3V) of at least 93%.

In some embodiments, the capacity retention is at least 94%, for example at least 95%, for example at least 96%, for example at least 97%.

Materials of the invention are also characterised by a surprisingly low direct current internal resistance (DCIR). DCIR tends to increase over time as the secondary cell or battery is cycled. It has been found that materials according to the invention provide a % increase in DCIR of less than 50% after 50 cycles, and in some cases an increase as low as 24%, when tested at a temperature of 23° C. in a half cell coin cell vs lithium, under a charge/discharge rate of 10 and voltage window of 3.0−4.3V, with an electrode loading of 9.0 mg/cm² and an electrode density of 3.0 g/cm³

The material may have a % increase in DCIR (after 50 cycles in a half cell coin cell vs Li, at an electrode loading of 9.0 mg/cm² and an electrode density of 3.0 g/cm³, tested at 23° C. and a 10 charge/discharge rate and voltage window of 3.0−4.3V) of less than 50%.

In some embodiments, the % increase in DCIR is less than 45%, for example less than 40%, for example less than 35%, for example less than 30%, for example less than 25%.

Materials of the invention are also characterised by a high specific capacity. It has been found that materials according to the invention when tested in a cell at 23° C., a 10 discharge rate and a voltage window of 3.0−4.3V, with an electrode loading of 9.0 mg/cm² and an electrode density of 3.0 g/cm³ in a half call coin cell vs Li metal, provide a specific capacity of at least 160 mAh/g, in some cases as high as 190 mAh/g. This high specific capacity in combination with the high capacity retention on cycling provides a cell or battery of improved performance with an extended usable lifetime which is useful in high performance applications such as in electric vehicles.

The material may have a specific capacity when tested in a cell at 23° C., a 10 discharge rate and a voltage window of 3.0−4.3V, with an electrode loading of 9.0 mg/cm² and an electrode density of 3.0 g/cm³ in a half call coin cell vs Li metal of at least 180 mAh/g. In some embodiments, the specific capacity is at least 190 mAh/g, for example at least 200 mAh/g.

The process for preparing the particulate lithium nickel oxide typically comprises the steps of:
mixing lithium-containing compound with a nickel-containing compound, a cobalt-containing compound, a magnesium-containing compound and optionally an M-containing compound and/or an aluminium containing compound, wherein a single compound may optionally contain two or more of Ni, Co, Mg, Al and M, to obtain a mixture;
calcining the mixture to obtain a first calcined material; and
contacting the first calcined material with an aluminium-containing compound and optionally one or more of a cobalt-containing compound, a lithium-containing compound and an M-containing compound in a surface-modification step to form an enriched surface layer on the first calcined material;

wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof.

In some embodiments, the first calcined material is a core material having Formula II:

Liₐ₁Niₓ₁Co_{y1}Mg_{z1}Alₚ₁M_{q1}O_{2+b1} Formula II

in which:
0.8≤a≤1.2
0.8≤x1<1
0.010≤y1≤0.12
0.007≤z1≤0.030
0≤p1≤0.01
0 q1≤0.2; and
−0.2≤b1≤0.2;
wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof.

In some embodiments, p1=0, such that the core material has the following formula:

Liₐ₁Niₓ₁Co_{y1}Mg_{z1}Alₚ₁M_{q1}O_{2+b1} Formula II

In some embodiments, the process includes a further calcination step after the surface modification step.

In some embodiments q1=0.

The lithium-containing compound may be selected from lithium hydroxide (e.g. LiOH or LiOH·H₂O), lithium carbonate (Li₂CO₃), and hydrated forms thereof. Lithium hydroxide may be particularly preferred.

The nickel-containing compound may be selected from nickel hydroxide (Ni(OH)₂), nickel oxide (NiO), nickel oxyhydroxide (NiOOH), nickel sulfate, nickel nitrate, nickel acetate and hydrated forms thereof. Nickel hydroxide may be particularly preferred.

The cobalt-containing compound may be selected from cobalt hydroxide (Co(OH)₂), cobalt oxide (CoO, Co₂O₃, Co₃O₄), cobalt oxyhydroxide (CoOOH), cobalt sulfate, cobalt nitrate, cobalt acetate and hydrated forms thereof. Cobalt hydroxide may be particularly preferred.

The magnesium-containing compound may be selected from magnesium hydroxide (Mg(OH)₂), magnesium oxide (MgO), magnesium sulfate, magnesium nitrate, magnesium acetate and hydrated forms thereof. Magnesium hydroxide may be particularly preferred.

The M-containing compound may be selected from M hydroxide, M oxide, M nitrate, M sulfate, M carbonate or M acetate and hydrated forms thereof. M hydroxide may be particularly preferred.

Alternatively, two or more of nickel, cobalt, magnesium and optionally M may be provided as a mixed metal hydroxide, e.g. a mixed nickel cobalt hydroxide or a mixed nickel cobalt M hydroxide. The mixed metal hydroxide may be a coprecipitated hydroxide. It may be polycrystalline.

The mixed metal hydroxide may have a composition according to Formula III:

NiₓCo_{y}Mg_{z}M_{q}(OH)_{2+b} Formula III

in which x, y, z, q and b are each independently as defined herein. If a cobalt enrichment step is carried out (as described below), it may be preferred that the value for y in Formula III is less than the value for y in Formula I.

Such mixed metal hydroxides may be prepared by co-precipitation methods well-known to the person skilled in the art. These methods may involve the co-precipitation of the mixed metal hydroxide from a solution of metal salts, such as metal sulfates, for example in the presence of ammonia and a base, such as NaOH. In some cases suitable mixed metal hydroxides may be obtainable from commercial suppliers known to the skilled person.

The calcination step may be carried out at a temperature of at least 400° C., at least 500° C., at least 600° C. or at least 650° C. The calcination step may be carried out at a temperature of 1000° C. or less, 900° C. or less, 800° C. or less or 750° C. or less. The material to be calcined may be at a temperature of 400° C., at least 500° C., at least 600° C. or at least 650° C. for a period of at least 2 hours, at least 5 hours, at least 7 hours or at least 10 hours. The period may be less than 24 hours.

The calcination step may be carried out under a CO₂-free atmosphere. For example, CO₂-free air may be flowed over the materials to be calcined during calcination and optionally during cooling. The CO₂-free air may, for example, be a mix of oxygen and nitrogen. The CO₂-free atmosphere may be oxygen (e.g. pure oxygen). Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

In some embodiments, the CO₂-free atmosphere comprises a mixture of O₂ and N₂. In some embodiments, the mixture comprises a greater amount of N₂ than O₂. In some embodiments, the mixture comprises N₂ and O₂ in a ratio of from 50:50 to 90:10, for example from 60:40 to 90:10, for example about 80:20.

In some embodiments, the particulate lithium nickel oxide material of Formula I comprises a surface-modified structure comprising a core and an enriched surface layer at the surface of the core, resulting from performing a surface-modification step on a core material having Formula II:

Liₐ₁Niₓ₁Co_{y1}Mg_{z1}Alₚ₁M_{q1}O_{2+b1} Formula II

in which:
0.8≤a1≤1.2
0.8≤x1<1
0.010≤y1≤0.12
0.007≤z1≤0.030
0≤p1≤0.01
0≤q1≤0.2; and
−0.2≤b1≤0.2;

wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof.

The surface modification step may comprise contacting the core material with an aluminium-containing compound and optionally one or more of a cobalt-containing compound, a lithium-containing compound and an M-containing compound. The aluminium-containing compound and optional cobalt-containing compound, lithium-containing compound and M-containing compound may be provided in solution, for example in aqueous solution.

In some embodiments, p1=0, such that the core material has the following formula:

Liₐ₁Niₓ₁Co_{y1}Mg_{z1}M_{q1}O_{2+b1}

In some embodiments q1=0.

The surface-modification step of the processes of the invention (also referred to herein as a surface enrichment step) comprises contacting the core material with cobalt, to increase the concentration of cobalt in the grain boundaries and/or at or near to the surface of the particles. In some embodiments, the surface-modification step (also referred to herein as a surface enrichment step) comprises contacting the core material with additional metal selected from one or more of aluminium, lithium and M, to increase the concentration of such metal in the grain boundaries and/or at or near to the surface of the particles. The surface modification may be carried out by contacting a core material with a cobalt-containing compound and optionally one or more further metal-containing compounds. For example, the compounds may be independently selected from nitrates, sulfates or acetates. Nitrates may be particularly preferred. The compounds may be provided in solution (e.g. aqueous solution). The compounds may be soluble in water.

The mixture of the core material with the cobalt-containing compound and optionally one or more further metal-containing compounds may be heated, for example to a temperature of at least 40° C., e.g. at least 50° C. The temperature may be less than 100° C. or less than 80° C. Where the cobalt-containing compound and optional one or more further metal-containing compounds is provided in solution, the mixture of the solution with the intermediate may be dried, e.g. by evaporation of the solvent or by spray drying.

The cobalt-containing compound and optional one or more further metal-containing compounds may be provided as a composition, referred to herein as a “surface modification composition”. The surface modification composition may comprise a solution of the cobalt-containing compound and optional one or more further metal-containing compounds (e.g. aqueous solution).

The surface modification composition may comprise a cobalt-containing compound and optionally one or more of a lithium-containing compound, an aluminium-containing compound and an M-containing compound. The surface modification composition may comprise a cobalt-containing compound and optionally one or more of a lithium-containing compound and an aluminium-containing compound. The surface modification composition may comprise a cobalt-containing compound, an aluminium-containing compound and optionally a lithium-containing compound. The surface modification composition may comprise a cobalt-containing compound as the sole metal-containing compound (i.e. thereby lacking a lithium-containing compound, an aluminium-containing compound and an M-containing compound).

The cobalt-containing compound, the aluminium-containing compound, lithium-containing compound and M-containing compound used in the surface modification step may be as defined above with reference to the cobalt-containing compound, the aluminium-containing compound, the lithium-containing compound and the M-containing compound used in the formation of the intermediate (core) material. It may be particularly preferred that the cobalt-containing compound and each of the one or more further metal-containing compounds is a metal-containing nitrate. It may be particularly preferred that the aluminium-containing compound is aluminium nitrate. It may be particularly preferred that the lithium-containing compound is lithium nitrate. It may be particularly preferred that the cobalt-containing compound is cobalt nitrate. It may be preferred that the cobalt-containing compound, the aluminium-containing compound and the lithium-containing compound are soluble in water.

In some embodiments, the surface modification step comprises contacting the core material with additional metal-containing compounds in an aqueous solution. The core material may be added to the aqueous solution to form a slurry or suspension. In some embodiments the slurry is agitated or stirred. In some embodiments, the weight ratio of core material to water in the slurry after addition of the core material to the aqueous solution is from about 1.5:1 to about 1:1.5, for example from about 1.4:1 to about 1:1.4, about 1.3:1 to about 1:1.3, about 1.2:1 to about 1:1.2 or about 1.1:1 to about 1:1.1. The weight ratio may be about 1:1.

Typically, the surface modification step is carried out after the first calcination step described above.

The surface modification step may be followed by a second calcination step. The second calcination step may be carried out at a temperature of at least 400° C., at least 500° C., at least 600° C. or at least 650° C. The second calcination step may be carried out at a temperature of 1000° C. or less, 900° C. or less, 800° C. or less or 750° C. or less. The material to be calcined may be at a temperature of 400° C., at least 500° C., at least 600° C. or at least 650° C. for a period of at least 30 minutes, at least 1 hour or at least 2 hours. The period may be less than 24 hours. The second calcination step may be shorter than the first calcination step.

The second calcination step may be carried out under a CO₂-free atmosphere as described above with reference to the first calcination step.

The process may include one or more milling steps, which may be carried out after the first and/or second calcination steps. The nature of the milling equipment is not particularly limited. For example, it may be a ball mill, a planetary ball mill or a rolling bed mill. The milling may be carried out until the particles (e.g. secondary particles) reach the desired size. For example, the particles of lithium nickel oxide (e.g. secondary particles) are typically milled until they have a D50 particle size of at least 5 μm, e.g. at least 5.5 μm, at least 6 μm or at least 6.5 μm. The particles of lithium nickel oxide (e.g. secondary particles) are typically milled until they have a D50 particle size of 15 μm or less, e.g. 14 μm or less or 13 μm or less.

The process of the present invention may further comprise the step of forming an electrode (typically a cathode) comprising the lithium nickel oxide material. Typically, this is carried out by forming a slurry of the particulate lithium nickel oxide, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the lithium nickel oxide. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention, and are not intended to limit its scope.

### EXAMPLES

### Comparative Example 1— Preparation of Base Materials

### Comparative Example 1A— Base 1 Li_{1.030}Ni_{0.953}Co_{0.030}Mg_{0.010}O₂

100 g Ni_{0.960}CO_{0.031}Mg_{0.099}(OH)₂ and 26.36 g LiOH were dry mixed in a poly-propylene bottle for 30 mins. The LiOH was pre-dried at 200° C. under vacuum for 24 hours and kept dry in a purged glovebox filled with dry N₂.

The powder mixture was loaded into 99%+ alumina crucibles and calcined under an artificial CO₂-free air mix which was 80:20 N₂:O₂. Calcination was performed as follows: to 450° C. (5° C./min) with 2 hours hold, ramp to 700° C. (2° C./min) with a 6 hour hold and cooled naturally to 130° C. The artificial air mix was flowing over the powder bed throughout the calcination and cooling. The title compound was thereby obtained.

The samples were then removed from the furnace at 130° C. and transferred to a high-alumina lined mill pot and milled on a rolling bed mill until D50 was between 12.0 and 12.5 μm.

D₅₀ was measured according to ASTM B822 of 2017 using a Malvern Mastersizer 3000 under the Mie scattering approximation and was found to be 9.5 μm. The chemical formula of the material was determined by ICP analysis to be Li_{1.030}Ni_{0.953}CO_{0.030}Mg_{0.010}O₂.

### Comparative Example 1B— Base 2 Li_{1.019}Ni_{0.949}CO_{0.031}Mg_{0.020}O₂

The procedure according to Comparative Example 1A was repeated except that 26.21 g of LiOH were dry mixed with 100 g Ni_{0.948}Co_{0.031}Mg_{0.021}(OH)₂. The title compound was thereby obtained. D₅₀ was found to be 10.2 μm. The chemical formula of the material was determined by ICP analysis to be Li_{1.019}Ni_{0.949}Co_{0.031}Mg_{0.020}O₂.

### Comparative Example 1C— Base 3 Li_{1.027}Ni_{0.923}Co_{0.049}Mg_{0.029}O₂

The procedure according to Comparative Example 1A was repeated except that 24.8 g of LiOH were dry mixed with 100 g Ni_{0.917}Co_{0.050}Mg_{0.033}(OH)₂. The title compound was thereby obtained. D₅₀ was found to be 9.65 μm. The chemical formula of the material was determined by ICP analysis to be Li_{1.027}Ni_{0.923}Co_{0.049}Mg_{0.029}O₂.

### Comparative Example 1D— Base 4 Li_{1.007}Ni_{0.923}Co_{0.049}Mg_{0.038}O₂

The procedure according to Comparative Example 1A was repeated except that 25.92 g of LiOH were dry mixed with 100 g Ni_{0.915}Co_{0.049}Mg_{0.036}(OH)₂. The title compound was thereby obtained. D₅₀ was found to be 12.2 μm. The chemical formula of the material was determined by ICP analysis to be Li_{1.007}Ni_{0.923}Co_{0.049}Mg_{0.038}O₂.

### Comparative Example 1E— Base 5 Li_{0.998}Ni_{0.917}Co_{0.049}Mg_{0.052}O₂

The procedure according to Comparative Example 1A was repeated except that 25.75 g of LiOH were dry mixed with 100 g Ni_{0.903}Co_{0.0481}Mg_{0.049}(OH)₂. The title compound was thereby obtained. The chemical formula of the material was determined by ICP analysis to be Li_{0.998}Ni_{0.917}Co_{0.049}Mg_{0.052}O₂.

### Comparative Example 1F— Base 6 Li_{1.024}Ni_{0.926}Co_{0.045}Mg_{0.037}O₂

The procedure according to Comparative Example 1A was repeated except that 25.94 g of LiOH were dry mixed with 100 g Ni_{0.918}Co_{0.045}Mg_{0.037}(OH)₂. The title compound was thereby obtained. D₅₀ was found to be 9.0 μm. The chemical formula of the material was determined by ICP analysis to be Li_{1.0241}Ni_{0.926}Co_{0.045}Mg_{0.037}O₂.

### Comparative Example 1G— Base 7 Li_{1.003}Ni_{0.956}Co_{0.030}Mg_{0.020}O₂

The procedure according to Comparative Example 1A was repeated except that 26.20 g of LiOH were dry mixed with 100 g Ni_{0.952}Co_{0.029}Mg_{0.019}(OH)₂. The title compound was thereby obtained. D₅₀ was found to be 9.6 μm. The chemical formula of the material was determined by ICP analysis to be Li_{1.003}Ni_{0.956}Co_{0.030}Mg_{0.020}O₂.

### Comparative Example 1H— Base 8 Li_{1.009}Ni_{0.957}Co_{0.030}Mg_{0.015}O₂

The procedure according to Comparative Example 1A was repeated except that 26.29 g of LiOH were dry mixed with 100 g Ni_{0.957}Co_{0.029}Mg_{0.014}(OH)₂. The title compound was thereby obtained. D₅₀ was found to be 9.3 μm. The chemical formula of the material was determined by ICP analysis to be Li_{1.009}Ni_{0.957}Co_{0.030}Mg_{0.015}O₂.

### Comparative Example 1J— Base 9 Li_{1.005}Ni_{0.944}Co_{0.029}Mg_{0.038}O₂

The procedure according to Comparative Example 1A was repeated except that 25.96 g of LiOH were dry mixed with 100 g Ni_{0.935}Co_{0.029}Mg_{0.037}(OH)₂. The title compound was thereby obtained. D₅₀ was found to be 10.7 μm. The chemical formula of the material was determined by ICP analysis to be Li_{1.005}Ni_{0.944}Co_{0.029}Mg_{0.038}O₂.

### Comparative Example 1K— Base 10 Li_{0.996}Ni_{0.914}Co_{0.053}Mg_{0.051}O₂

The procedure according to Comparative Example 1A was repeated except that 25.75 g of LiOH were dry mixed with 100 g Ni_{0.900}Co_{0.053}Mg_{0.048}(OH)₂. The title compound was thereby obtained. D₅₀ was found to be 9.49 μm. The chemical formula of the material was determined by ICP analysis to be Li_{0.996}Ni_{0.914}Co_{0.053}Mg_{0.051}O₂.

Bases 12 to 20, listed in Table 3 below, were made by an analogous process to Bases 1 to 10.

### Example 1— Preparation of Surface-Modified Materials

### Example 1A— Compound 1 Li_{1.018}Ni_{0.930}Co_{0.049}Mg_{0.010}Al_{0.006}O₂

The product of Comparative Example 1A was sieved through a 53 μm sieve and transferred to a N₂-purged glovebox. An aqueous solution containing 5.91 g Co(NO₃)₂.6H₂O, 0.47 g LiNO₃ and 2.44 g Al(NO₃)₃.9H₂O in 100 mL water was heated to between 60 and 65° C. 100 g of the sieved powder was added rapidly while stirring vigorously. The slurry was stirred at a temperature between 60 and 65° C. until the supernatant was colourless. The slurry was then spray-dried.

After spray-drying powders were loaded into 99%+ alumina crucibles and calcined under an artificial CO₂-free air mix which was 80:20 N₂:O₂. Calcination was performed as follows: ramp to 130° C. (5° C./min) with 5.5 hours hold, ramp to 450° C. (5° C./min) with 1 hour hold, ramp to 700° C. (2° C./min) with a 2 hours hold and cooled naturally to 130° C. The artificial air mix was flowing over the powder bed through the calcination and cooling. The title compound was thereby obtained.

The samples were then removed from the furnace at 130° C. and transferred to a purged N₂-filled glove-box.

The sample was milled in a high-alumina lined mill pot on a rolling bed mill. The target end point of the milling was when D₅₀ was between 10 and 11 μm; D₅₀ was measured after milling and found to be 9.5 μm. The sample was passed through a 53 μm sieve and stored in a purged N₂ filled glove-box. The water content of the material was 0.18 wt %. The chemical formula of the material was determined by ICP analysis to be

Li_{1.018}Ni_{0.930}Co_{0.049}Mg_{0.010}Al_{0.006}O₂.

### Example 1— Compound 2 Li_{1.002}Ni_{0.927}Co_{0.053}Mg_{0.020}, Al_{0.0065}O₂

The product of Comparative Example 1B was subjected to the procedure set out under Example 1A, except that the aqueous solution contained 5.90 g Co(NO₃)₂·6H₂O, 0.47 g LiNO₃ and 2.43 g Al(NO₃)₃.9H₂O in 100 mL water. The title compound was thereby obtained. D₅₀ was found to be 8.5 μm. The water content of the material was 0.28 wt %.

The chemical formula of the material was determined by ICP analysis to be

Li_{1.002}Ni_{0.927}Co_{0.053}Mg_{0.020}Al_{0.0065}O₂.

### Example 1C— Compound 3 Li_{0.995}Ni_{0.909}Co_{0.068}Mg_{0.027}Al_{0.0065}O₂

The product of Comparative Example 10 was subjected to the procedure set out under Example 1A, except that the aqueous solution contained 5.89 g Co(NO₃)₂·6H₂O, 0.46 g LiNO₃ and 2.43 g Al(NO₃)₃·9H₂O in 100 mL water. The title compound was thereby obtained. D₅₀ was found to be 7.61 μm. The water content of the material was 0.2 wt %. The chemical formula of the material was determined by ICP analysis to be

Li_{0.995}Ni_{0.909}Co_{0.068}Mg_{0.027}Al_{0.0065}O₂.

### Example 1 D— Compound 4 Li_{0.985}Ni_{0.913}Co_{0.061}Mg_{0.037}Al_{0.0069}O₂

The product of Comparative Example 1D was subjected to the procedure set out under Example 1A, except that the aqueous solution contained 3.94 g Co(NO₃)₂·6H₂O and 2.43 g Al(NO₃)₃·9H₂O in 100 mL water, but did not contain any LiNO₃. The title compound was thereby obtained. D₅₀ was found to be 11.7 μm. The water content of the material was 0.26 wt %. The chemical formula of the material was determined by ICP analysis to be

Li_{0.985}Ni_{0.913}Co_{0.061}Mg_{0.037}Al_{0.0069}O₂.

### Example 1E— Compound 5 Li_{0.980}Ni_{0.905}Co_{0.061}Mg_{0.051}Al_{0.0065}O₂

The product of Comparative Example 1E was subjected to the procedure set out under Example 1A, except that the aqueous solution contained 3.93 g Co(NO₃)₂·6H₂O and 2.42 g Al(NO₃)₃·9H₂O in 100 mL water, but did not contain any LiNO₃. The title compound was thereby obtained. D₅₀ was found to be 10.7 μm. The water content of the material was 0.09 wt %. The chemical formula of the material was determined by ICP analysis to be

Li_{0.980}Ni_{0.905}Co_{0.061}Mg_{0.051}Al_{0.0065}O₂.

### Example 1F Compound 6 Li_{1.003}Ni_{0.923}Co_{0.045}Mg_{0.038}Al_{0.0062}O₂

The product of Comparative Example 1F was subjected to the procedure set out under Example 1A, except that the aqueous solution contained 2.43 g Al(NO₃)₃·9H₂O in 100 mL water, but did not contain any Co(NO₃)₂.6H₂O or LiNO₃. The title compound was thereby obtained. D₅₀ was found to be 7.5 μm. The water content of the material was 0.18 wt %. The chemical formula of the material was determined by ICP analysis to be

Li_{1.003}Ni_{0.923}Co_{0.045}Mg_{0.038}Al_{0.0062}O₂.

### Example 1G— Compound 7 Li_{0.997}Ni_{0.952}Co_{0.029}Mg_{0.019}Al_{0.0065}O₂

The product of Comparative Example 1G was subjected to the procedure set out under Example 1A, except that the aqueous solution contained 2.44 g Al(NO₃)₃·9H₂O in 100 mL water, but did not contain any Co(NO₃)₂·6H₂O or LiNO₃. The title compound was thereby obtained. D₅₀ was found to be 7.9 μm. The water content of the material was 0.29 wt %. The chemical formula of the material was determined by ICP analysis to be

Li_{0.997}Ni_{0.952}Co_{0.029}Mg_{0.019}Al_{0.0065}O₂.

### Example 1H— Compound 8 Li_{1.002}Ni_{0.919}Co_{0.064}Mg_{0.014}Al_{0.0062}O₂

The product of Comparative Example 1H was subjected to the procedure set out under Example 1A, except that the aqueous solution contained 11.82 g Co(NO₃)₂·6H₂O, 1.88 g LiNO₃ and 2.44 g Al(NO₃)₃·9H₂O in 100 mL water. The title compound was thereby obtained. D₅₀ was found to be 8.2 μm. The water content of the material was 0.29 wt %. The chemical formula of the material was determined by ICP analysis to be

Li_{1.002}Ni_{0.919}Co_{0.064}Mg_{0.014}Al_{0.0062}O₂.

### Example 1J— Compound 9 Li_{0.980}Ni_{0.909}Co_{0.066}Mg_{0.037}Al_{0.0066}O₂

The product of Comparative Example 1J was subjected to the procedure set out under Example 1A, except that the aqueous solution contained 11.77 g Co(NO₃)₂·6H₂O, 1.87 g LiNO₃ and 2.44 g Al(NO₃)₃·9H₂O in 100 mL water. The title compound was thereby obtained. D₅₀ was found to be 10.0 μm. The water content of the material was 0.08 wt %. The chemical formula of the material was determined by ICP analysis to be

Li_{0.980}Ni_{0.909}Co_{0.066}Mg_{0.037}Al_{0.0066}O₂.

### Example 1K— Compound 10 Li_{0.987}Ni_{0.900}Co_{0.064}Mg_{0.051}Al_{0.0065}O₂

The product of Comparative Example 1K was subjected to the procedure set out under Example 1A, except that the aqueous solution contained 3.93 g Co(NO₃)₂·6H₂O and 2.42 g Al(NO₃)₃·9H₂O in 100 mL water, but did not contain any LiNO₃. The title compound was thereby obtained. D₅₀ was found to be 9.4 μm. The water content of the material was 0.17 wt %. The chemical formula of the material was determined by ICP analysis to be

Li_{0.987}Ni_{0.900000.064}Mg_{0.051}Al_{0.0065}O₂.

### Example 1L— Compound 11 Li_{0.984}Ni_{0.877}Co_{0.115}Mg_{0.010}Al_{0.0066}O₂

100 g Ni_{0.905}Co_{0.084}Mg_{0.010}(OH)₂ and 26.33 g LiOH were dry mixed in a poly-propylene bottle for 1 hour. The LiOH was pre-dried at 200° C. under vacuum for 24 hours and kept dry in a glovebox purged with dry N₂.

The powder mixture was loaded into 99%+ alumina crucibles and calcined under an artificial CO₂ free air mix which was 80:20 N₂:O₂. Calcination was performed as follows: to 450° C. (5° C./min) with 2 hours hold, ramp to 700° C. (2° C./min) with a 6 hour hold and cooled naturally to 130° C. The artificial air mix was flowing over the powder bed throughout the calcination and cooling.

The samples were then removed from the furnace at 130° C. and transferred to a purged N₂ filled glove-box. The sample was transferred to a high-alumina lined mill pot and milled on a rolling bed mill until D₅₀ was between 12.0−12.5 μm.

After milling, the product was sieved through a 53 μm sieve and transferred to a purged N₂ filled glovebox. An aqueous solution containing 11.83 g Co(NO₃)₂·6H₂O, 1.88 g LiNO₃ and 2.44 g Al(NO₃)₃·9H₂O in 100 mL water was heated to between 60 and 65° C. 100 g of the sieved powder was added rapidly while stirring vigorously. The slurry was stirred at a temperature between 60 and 65° C. until the supernatant was colourless. The slurry was then spray-dried.

After spray-drying powders were loaded into 99%+ alumina crucibles and calcined under an artificial CO₂ free air mix which was 80:20 N₂:O₂. Calcination was performed as follows: ramp to 130° C. (5° C./min) with 5.5 hours hold, ramp to 450° C. (5° C./min) with 1 hour hold, ramp to 700° C. (2° C./min) with a 2 hours hold and cooled naturally to 130° C. The artificial air mix was flowing over the powder bed through the calcination and cooling. The title compound was thereby obtained.

The samples were then removed from the furnace at 130° C. and transferred to a N₂ filled glove-box.

The sample was milled in a high-alumina lined mill pot on a rolling bed mill. The end point of the milling was when D₅₀ was between 10 and 11 μm; D₅₀ was measured after milling and found to be 8.8 μm. The sample was passed through a 53 μm sieve and stored in a purged N₂ filled glove-box.

The water content of the material was 0.4 wt %. The chemical formula of the material was determined by ICP analysis to be Li_{0.984}Ni_{0.877}Co_{0.115}Mg_{0.010}Al_{0.0066}O₂.

Compounds 12 to 20, listed in Table 3 below, were made by an analogous process to Compounds 1 to 10, using the following bases:

TABLE 1

| Compound | Base |
|---|---|
| Compound 12 | Base 12 |
| Compound 13 | Base 13 |
| Compound 14 | Base 14 |
| Compound 15 | Base 15 |
| Compound 16 | Base 16 |
| Compound 17a | Base 17 |
| Compound 17b | Base 17 |
| Compound 18a | Base 18 |
| Compound 18b | Base 18 |
| Compound 19 | Base 19 |
| Compound 20 | Base 20 |

Li₂CO₃ Content

Surface Li₂CO₃ content in samples was determined using a two-stage titration with phenolphthalein and bromophenol blue. For the titration, surface lithium carbonate was extracted from a sample of each material by agitating in deionised water for 5 minutes to provide an extractate solution, the extractate solution was separated from residual solid. Phenolphthalein indictor was added to the extractate solution, and the extracted solution was titrated using HCl solution until the extractate solution became clear (indicating the removal of any LiOH). Bromophenol blue indictor was added to the extractate solution, and the extracted solution titrated using HCl solution until the extractate solution turned yellow. The amount of lithium carbonate in the extractate solution was be calculated from this bromophenol titration step, the wt % of surface lithium carbonate in each sample was calculated assuming 100% extraction of surface lithium carbonate into the extractate solution.

The results for the materials tested were as set out in Table 2:

TABLE 2

| Material | Li₂CO₃ content (wt %) |
|---|---|
| Compound 1 | 0.28 |
| Compound 2 | 0.26 |
| Compound 3 | 0.16 |
| Compound 4 | 0.36 |
| Compound 5 | 0.41 |
| Compound 6 | 0.40 |
| Compound 7 | 0.53 |
| Compound 8 | 0.19 |
| Compound 9 | 0.15 |
| Compound 10 | 0.31 |
| Compound 11 | 0.19 |
| Compound 12 | 0.1 |
| Compound 13 | 0.89 |
| Compound 14 | 0.23 |
| Compound 15 | 0.16 |
| Compound 16 | 0.18 |
| Compound 17a | 0.19 |
| Compound 17b | 1.02 |
| Compound 18a | 0.19 |
| Compound 18b | 0.918 |
| Compound 19 | 0.11 |
| Compound 20 | 0.61 |

### Compositional Analysis

The total magnesium and cobalt contents (weight % based on the total particle weight) in the Comparative and Inventive materials was determined by ICP and is given in Table 3 below.

The surface cobalt content was calculated by subtracting the ICP wt % Co in the base material from the ICP wt % Co in the final material. The core cobalt content is taken as the ICP wt % Co in the base material.

### ICP (Inductively Coupled Plasma)

The elemental composition of the compounds was measured by ICP-OES. For that, 0.1 g of material are digested with aqua regia (3:1 ratio of hydrochloric acid and nitric acid) at −130° C. and made up to 100 mL. The ICP-OES analysis was carried out on an Agilent 5110 using matrix matched calibration standards and yttrium as an internal standard. The lines and calibration standards used were instrument-recommended.

### Electrochemical Testing

Electrodes were made in a 94:3:3≤active:carbon:binder formulation with an ink at 65% solids. 0.6 g of SuperC65 carbon was mixed with 5.25 g of N-methyl pyrrolidone (NMP) on a Thinky® mixer. 18.80 g of active material was added and further mixed using the Thinky® mixer. Finally, 6.00 g of Solef® 5130 binder solution (10 wt % in NMP) was added and mixed in the Thinky mixer. The resulting ink was cast onto aluminium foils using a 125 μm fixed blade coater and dried at 120° C. for 60 minutes. Once dry, the electrode sheet was calendared in an MTI calendar to achieve a density of 3 g/cm³. Individual electrodes were cut and dried under vacuum overnight before transferring to an argon filled glove-box. Coin cells were built using a lithium anode and 1M LiPF₆ in 1:1:1 EC (ethylene carbonate): EMC (ethyl methyl carbonate) : DMC (dimethyl carbonate)+1 wt % VC (vinylene carbonate) electrolyte. Electrodes selected had a loading of 9.0 mg/cm² and a density of 3 g/cm³.

Electrochemical measurements were taken from averages of three cells measured at 23° C., and a voltage window of 3.0−4.3V.

Electrochemical characteristics evaluated include first cycle efficiency (FCE), 0.1 C specific capacity, 1.0 C specific capacity, capacity retention and DCIR growth using a 10 s pulse.

Capacity retention and DCIR growth were determined based on performance after 50 cycles at 1 C.

Table 3 below includes details of the materials tested.

TABLE 3

| | | | | | Specific | Specific | | | DCIR |
|---|---|---|---|---|---|---|---|---|---|
| | | Mg | Total Co | | capacity | capacity | | | growth, |
| | | content | content | D₅₀ | at 1 C | at 0.1 C | CR | FCE | 10 s |
| Material | Formula | (wt %) | (wt %) | (μm) | (mAh/g) | (mAh/g) | (%) | (%) | (%) |
| Base 1 | Li_{1.030}Ni_{0.953}Co_{0.030}Mg_{0.010}O₂ | 0.2 | 1.8 | 9.5 | 194.6 | 213.9 | 80.9 | 87.3 | 29 |
| Base 2 | Li_{1.019}Ni_{0.949}Co_{0.031}Mg_{0.020}O₂ | 0.5 | 1.8 | 10.2 | 190.2 | 208.1 | 85.8 | 85.8 | 34 |
| Base 3 | Li_{1.027}Ni_{0.923}Co_{0.049}Mg_{0.029}O₂ | 0.7 | 2.9 | 9.65 | 185.0 | 203.1 | 93.5 | 87.2 | 34 |
| Base 4 | Li_{1.007}Ni_{0.923}Co_{0.049}Mg_{0.038}O₂ | 0.9 | 2.9 | 12.2 | nm | nm | nm | nm | nm |
| Base 5 | Li_{0.998}Ni_{0.917}Co_{0.049}Mg_{0.052}O₂ | 1.3 | 2.9 | 12.1 | nm | nm | nm | nm | nm |
| Base 6 | Li_{1.024}Ni_{0.926}Co_{0.045}Mg_{0.037}O₂ | 0.9 | 2.7 | 9.0 | 180.6 | 197.9 | 96.4 | 85.2 | 32 |
| Base 7 | Li_{1.003}Ni_{0.956}Co_{0.030}Mg_{0.020}O₂ | 0.5 | 1.8 | 9.6 | 193.4 | 211.5 | 84.8 | 87.3 | 32 |
| Base 8 | Li_{1.009}Ni_{0.957}Co_{0.030}Mg_{0.015}O₂ | 0.4 | 1.8 | 9.3 | 196.3 | 218.1 | 80.7 | 89.2 | 38 |
| Base 9 | Li_{1.005}Ni_{0.944}Co_{0.029}Mg_{0.038}O₂ | 0.9 | 1.7 | 10.7 | 182.7 | 198.2 | 91.0 | 84.1 | 30 |
| Base 10 | Li_{0.996}Ni_{0.914}Co_{0.053}Mg_{0.051}O₂ | 1.3 | 3.2 | 9.49 | nm | nm | nm | nm | nm |
| Base 12 | Li_{1.026}Ni_{0.930}Co_{0.049}Mg_{0.019}O₂ | 0.5 | 2.9 | 8.4 | 192.5 | 212.4 | 92.3 | 88.5 | 40 |
| Base 13 | Li_{1.018}Ni_{0.911}Co_{0.058}Mg_{0.038}O₂ | 0.9 | 3.5 | 9.4 | 176.7 | 194.1 | 95.6 | 85.4 | 34 |
| Base 14 | Li_{1.021}Ni_{0.930}Co_{0.048}Mg_{0.028}O₂ | 0.7 | 2.9 | 9.8 | 180.6 | 195.81 | 92.0 | 84.9 | 43 |
| Base 15 | Li_{1.035}Ni_{0.921}Co_{0.048}Mg_{0.029}O₂ | 0.7 | 2.9 | 9.8 | 183.4 | 201.68 | 91.2 | 86.4 | 39 |
| Base 16 | Li_{1.013}Ni_{0.902}Co_{0.081}Mg_{0.020}O₂ | 0.5 | 4.8 | 8.9 | 182.69 | 204.63 | 91.8 | 89.1 | 45 |
| Base 17 | Li_{1.033}Ni_{0.904}Co_{0.079}Mg_{0.009}O₂ | 0.2 | 4.7 | 10.2 | 190.0 | 212.9 | 91.4 | 89.4 | 40 |
| Base 18 | Li_{1.013}Ni_{0.900}Co_{0.075}Mg_{0.038}O₂ | 0.9 | 4.5 | 12 | 174.96 | 193.09 | 96.6 | 84.8 | 31 |
| Base 19 | Li_{1.041}Ni_{0.925}Co_{0.048}Mg_{0.019}O₂ | 0.5 | 2.9 | 9.8 | 189.9 | 209.2 | 88.8 | 88.1 | 34 |
| Base 20 | Li_{1.017}Ni_{0.907}Co_{0.068}Mg_{0.029}O₂ | 0.7 | 4.0 | 9.4 | 181.9 | 211.5 | 94.5 | 87.3 | 36 |

| | | | | | | Specific | Specific | | | |
|---|---|---|---|---|---|---|---|---|---|---|
| | | Mg | Surface Co | Total Co | | capacity | capacity | | | DCIR |
| | | content | content | content | D₅₀ | at 1 C | at 0.1 C | CR | FCE | growth, |
| Material | Formula | (wt %) | (wt %) | (wt %) | (μm) | (mAh/g) | (mAh/g) | (%) | (%) | 10 s (%) |
| Compound 1 | Li_{1.018}Ni_{0.930}Co_{0.049}Mg_{0.010}Al_{0.006}O₂ | 0.2 | 1.1 | 2.9 | 8.5 | 198.5 | 216.5 | 87.4 | 88.3 | 38 |
| Compound 2 | Li_{1.002}Ni_{0.927}Co_{0.053}Mg_{0.020}Al_{0.0065}O₂ | 0.5 | 1.3 | 3.2 | 9.5 | 192.9 | 209.6 | 93.9 | 87.4 | 39 |
| Compound 3 | Li_{0.995}Ni_{0.909}Co_{0.068}Mg_{0.027}Al_{0.0065}O₂ | 0.7 | 1.2 | 4.1 | 7.61 | 185.2 | 203 | 95.4 | 95.4 | 37 |
| Compound 4 | Li_{0.985}Ni_{0.913}Co_{0.061}Mg_{0.037}Al_{0.0069}O₂ | 0.9 | 0.7 | 3.7 | 11.7 | 176.1 | 192.7 | 96.2 | 84.3 | 29 |
| Compound 5 | Li_{0.980}Ni_{0.905}Co_{0.06i}Mg_{0.051}Al_{0.0065}O₂ | 1.3 | 0.7 | 3.7 | 10.7 | 166.7 | 184.1 | 97.4 | 82.3 | 27 |
| Compound 6 | Li_{1.003}Ni_{0.923}Co_{0.045}Mg_{0.038}Al_{0.0062}O₂ | 0.9 | 0 | 2.7 | 7.5 | 177.4 | 192.3 | 97.4 | 82.9 | 29 |
| Compound 7 | Li_{0.997}Ni_{0.952}Co_{0.029}Mg_{0.019}Al_{0.0065}O₂ | 0.5 | 0 | 1.8 | 7.9 | 190.4 | 206.5 | 87.1 | 86.1 | 24 |
| Compound 8 | Li_{1.002}Ni_{0.919}Co_{0.064}Mg_{0.014}Al_{0.0062}O₂ | 0.4 | 2.1 | 3.9 | 8.2 | 198.7 | 218.4 | 91.5 | 91.2 | 48 |
| Compound 9 | Li_{0.980}Ni_{0.909}Co_{0.066}Mg_{0.037}Al_{0.0066}O₂ | 0.9 | 2.2 | 3.9 | 10.0 | 177.6 | 192.1 | 94.2 | 84.5 | 36 |
| Compound 10 | Li_{0.987}Ni_{0.900}Co_{0.064}Mg_{0.051}Al_{0.0065}O₂ | 1.3 | 0.7 | 3.9 | 9.4 | 171.6 | 188.4 | 97.2 | 83.8 | 33 |
| Compound 11 | Li_{0.984}Ni_{0.877}Co_{0.115}Mg_{0.010}Al_{0.0066}O₂ | 0.2 | 2.2 | 6.9 | 8.8 | 191.2 | 210.2 | 94.3 | 90.8 | nm |
| Compound 12 | Li_{0.995}Ni_{0.893}Co_{0.091}Mg_{0.019}Al_{0.006}O₂ | 0.5 | 2.5 | 5.5 | 8.4 | 188.0 | 206.8 | 96.2 | 89.2 | 46 |
| Compound 13 | Li_{1.018}Ni_{0.904}Co_{0.058}Mg_{0.038}Al_{0.007}O₂ | 0.9 | 0 | 3.5 | 8.2 | 173.1 | 188.8 | 96.0 | 84.4 | 24 |
| Compound 14 | Li_{1.009}Ni_{0.906}Co_{0.067}Mg_{0.028}Al_{0.007}O₂ | 0.7 | 1.1 | 4.0 | 8.8 | 177.9 | 193.6 | 97.3 | 84.6 | 23 |
| Compound 15 | Li_{0.988}Ni_{0.896}Co_{0.083}Mg_{0.027}Al_{0.006}O₂ | 0.7 | 2.2 | 5.0 | 8.2 | 182.9 | 200.3 | 95.3 | 95.3 | 37 |
| Compound 16 | Li_{1.009}Ni_{0.880}Co_{0.097}Mg_{0.019}Al_{0.007}O₂ | 0.5 | 1.0 | 5.8 | 7.1 | 188.9 | 208.8 | 95.6 | 89.9 | 36 |
| Compound 17a | Li_{0.992}Ni_{0.874}Co_{0.116}Mg_{0.009}Al_{0.007}O₂ | 0.2 | 2.2 | 6.9 | 8.6 | 189.6 | 208.6 | 92.5 | 90.3 | 44 |
| Compound 17b | Li_{1.017}Ni_{0.901}Co_{0.080}Mg_{0.010}Al_{0.007}O₂ | 0.2 | 0 | 4.7 | 8.3 | 185.4 | 202.8 | 90.6 | 90.6 | 37 |
| Compound 18a | Li_{0.984}Ni_{0.862}Co_{0.113}Mg_{0.036}Al_{0.007}O₂ | 0.9 | 2.3 | 6.7 | 11.2 | 172.5 | 189.2 | 98.6 | 85.1 | 31 |
| Compound 18b | Li_{1.002}Ni_{0.892}Co_{0.076}Mg_{0.038}Al_{0.007}O₂ | 0.9 | 0 | 4.5 | 11.2 | 171.0 | 187.0 | 97.2 | 83.5 | 25 |
| Compound 19 | Li_{1.009}Ni_{0.896}Co_{0.083}Mg_{0.018}Al_{0.006}O₂ | 0.5 | 2.1 | 4.9 | 9.0 | 189.2 | 207.2 | 94.6 | 88.8 | 39 |
| Compound 20 | Li_{1.016}Ni_{0.901}Co_{0.068}Mg_{0.029}Al_{0.007}O₂ | 0.7 | 0 | 4.0 | 8.0 | 183.6 | 202.0 | 93.3 | 87.0 | 37 |

CR = Capacity retention
FCE = First cycle efficiency
DCIR = Direct current internal resistance
nm = not measured

### Design of Experiments Approach

Traditionally experiments are planned varying one factor at a time whilst keeping the other factors constant. An alternative approach is “Design of Experiments”, where multiple variables are changed at once, allowing a large experimental space to be covered using relatively few experimental points. A computer-based statistical analysis is then applied to ascertain the key interactions.

The compounds made in the Examples above were prepared and analysed according to a Design of Experiments approach. Statistical analysis determined the following correlations and p-values (with the p-value indicating the statistical significance of the results and a p-value of <0.05 signifying a statistically significant result), as shown in Table 4 below.

TABLE 4

| | | P-values | | |
|---|---|---|---|---|
| | | Mg | Co | Co in |
| Feature | Correlation | content | in core | surface layer |
| Capacity (1 C) | Negative | <0.0001 | 0.0037 | 0.8920 |
| Capacity (0.1 C) | Negative | <0.0001 | 0.0476 | 0.8166 |
| Capacity Retention | Positive | <0.0001 | 0.0204 | 0.0086 |

This shows that Mg content and Co content in the core have a negative impact on capacity, with Mg having a stronger effect. However, the impact of Co content in the surface layer on capacity is not statistically significant.

In contrast, all three of Mg content, Co content in the core and Co content in the surface later have a positive impact on capacity retention. Interestingly, the amount of Co in the shell has a stronger impact on capacity retention than the amount in the core. In combination with the observation that Co content in the surface layer does not have a statistically significant impact on reducing capacity, shifting Co content from the core of the material to the surface layer provides a strategy for increasing capacity retention while maintaining excellent capacity.

1. A surface-modified particulate lithium nickel oxide material comprising particles having Formula I
LiₐNiₓCo_{y}Mg_{z}AlₚM_{q}O_{2+b} Formula I
in which:
0.8≤a≤1.2
0.8≤x<1
0.010≤y≤0.12
0.007≤z≤0.030
0≤p≤0.01
0≤q≤0.2; and
−0.2≤b≤0.2;
wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof; and
wherein the particles comprise a core and an enriched surface layer at the surface of the core, and
wherein the enriched surface layer includes 0.8 wt % or more cobalt based on the total weight of the particle.

2. The particulate lithium nickel oxide material according to claim 1 wherein the surface enriched layer includes 1 wt % or more of cobalt based on the total weight of the particle.

3. The particulate lithium nickel oxide material according to claim 1, wherein y≤0.10 and/or wherein 0.012≤z.

4. The particulate lithium nickel oxide material according to claim 1, wherein y≤0.093, y≤0.090, or y≤0.085

5. The particulate lithium nickel oxide material according to claim 1, wherein (i) 0.055≤y or 0.060≤y and/or (ii) 0.022≤z.

6. The particulate lithium nickel oxide material according to claim 1, wherein 0.018≤z.

7. The particulate lithium nickel oxide material according to claim 1, having a D₅₀ particle size in the range from 4 μm to 20 μm.

8. The particulate lithium nickel oxide material according to claim 1, wherein the c-axis contraction during the H2→H3 phase transition within the material is less than 3.9%, as measured by ex-situ XRPD.

9. The particulate lithium nickel oxide material according to claim 1, wherein the capacity retention of the particulate lithium nickel oxide material after 50 cycles, tested in a cell at 23° C. and a 1 C charge/discharge rate, at an electrode loading of 9.0 mg/cm² and an electrode density of 3.0 g/cm³, is at least 93%, and/or wherein the % increase in DCIR of the particulate lithium nickel oxide material after 40 cycles, tested in a cell at 23° C. and a 1 C charge/discharge rate, at an electrode loading of 9.0 mg/cm² and an electrode density of 3.0 g/cm³, is less than 50%, and/or
wherein the specific capacity of the particulate lithium nickel oxide material, tested in a cell at 23° C. and a 1 C charge/discharge rate, at an electrode loading of 9.0 mg/cm² and an electrode density of 3.0 g/cm³, is at least 160 mAh/g.

10. A process for preparing particulate lithium nickel oxide material having Formula I
LiₐNiₓCo_{y}Mg_{z}AlₚM_{q}O_{2+b} Formula I
in which:
0.8≤a≤1.2
0.8≤x<1
0.010≤y≤0.12
0.010≤z≤0.030
0≤p≤0.01
0≤q≤0.2; and
−0.2≤b≤0.2;
wherein M is selected from Mn, V, Ti, B, Zr, Sr, Ca, Cu, Sn, Cr, Fe, Ga, Si, W, Mo, Ta, Y, Sc, Nb, Pb, Ru, Rh and Zn and combinations thereof; and
the process comprising the steps of:
mixing lithium-containing compound with a nickel-containing compound, a cobalt-containing compound, a magnesium-containing compound and optionally an M-containing compound and/or an aluminium-containing compound, wherein a single compound may optionally contain two or more of Ni, Co, Mg, Al and M, to obtain a mixture;
calcining the mixture to obtain a calcined material; and
contacting the first calcined material with a cobalt containing compound and optionally one or more of an aluminium-containing compound, a lithium-containing compound and an M-containing compound in a surface-modification step to form an enriched surface layer on the first calcined material, such that the surface enriched layer includes 0.8 wt % or more cobalt based on the total weight of the particle.

11. A cathode comprising the particulate lithium nickel oxide material according to claim 1.

12. A lithium secondary cell or battery comprising the cathode according to claim 11.

13. A method, comprising incorporating Use of the particulate lithium nickel oxide according to claim 1 to improve the capacity retention of a lithium secondary cell or battery.
